(19) United States
(12) Patent Application Publication
(10) Pub. No.: US 2010/0287490 A1
(43) Pub. Date: Nov. 11, 2010

(54) INFORMATION PROCESSING APPARATUS, CONTROL METHOD FOR INFORMATION PROCESSING APPARATUS, AND STORAGE MEDIUM

(75) Inventor: Hideshi Ichimi, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/768,543

(22) Filed: Apr. 27, 2010

(30) Foreign Application Priority Data
May 8, 2009 (JP) 2009-113302

(51) Int. Cl. G06F 3/048

(52) U.S. Cl. 715/772; 715/773

(57) ABSTRACT

A control method for controlling an information processing apparatus configured to display an operation screen including a plurality of keys on a display unit, and when any one of the plurality of keys is selected, to execute a process according to a process content registered in association with the selected key. The method includes setting, for each key of the plurality of keys, whether to cause the display unit to display a status of a process executed in response to selection of the selected key, and controlling the display unit to display the status of the process corresponding to the selected key if it is set to cause the display unit to display the status of the process executed in response to selection of the selected key when the key is selected, and to maintain display of the operation screen including the plurality of keys if it is not.

### BACKGROUND OF THE INVENTION

1. Field of the Invention

The present invention relates to an information processing apparatus, a control method for the information processing apparatus, and a storage medium.

2. Description of the Related Art

Conventionally, specific processes in an information processing apparatus are executed with an operation screen displayed on a liquid crystal display (LCD) provided with a touch panel so that a user can press a key provided on the operation screen. In addition, a function may be provided in which settings or process contents used often by a user are set in an arbitrary key and selection of that key executes processing according to the registered process contents (refer to Japanese Patent Application Laid-Open No. 04-373012). These functions include a screen transition, when the key is pressed, to an application that is actually executing processing according to the process contents registered on the selected key. For example, a processing status is displayed. In this manner, a user can confirm a processing status executed according to key selection via the screen.

However, when a screen is switched by key selection, during the period until the process executed according to key selection is completed, although a user may want to select another key provided on the operation screen, execution of the subsequent process may not be possible. For example, in a multifunctional peripheral (MFP), which is capable of performing copy processing and fax processing in parallel, the fax processing cannot be executed until the copy processing is completed, thus resulting in wasteful downtime. Although there can be considered a proposal to execute processing according to process contents executed in response to key selection without executing a screen transition, it may be difficult for a user to perform simple confirmation of the processing status executed according to key selection.

### SUMMARY OF THE INVENTION

According to an aspect of the present invention, an information processing apparatus configured is to display an operation screen including a plurality of keys on a display unit, and when anyone of the plurality of keys is selected, to execute a process according to a process content registered in association with the selected key. The information processing apparatus includes a setting unit configured to set, for each key of the plurality of keys, whether to cause the display unit to display a status of a process executed in response to selection of the selected key included in the operation screen, and a display control unit configured to control the display unit to display the status of the process corresponding to the selected key if it is set by the setting unit to cause the display unit to display the status of the process executed in response to selection of the key when the selected key is selected, and to maintain display of the operation screen including the plurality of keys if it is not set by the setting unit to cause the display unit to display the status of the process executed in response to selection of the selected key when the key is selected.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating the configuration of an image processing apparatus according to an exemplary embodiment of the present invention.

FIG. 2 is a plan view illustrating the configuration of an operation unit illustrated in FIG. 1.

FIG. 3 illustrates an example of a user interface (UI) displayed on the operation unit illustrated in FIG. 1.

FIG. 4 illustrates an example of a UI displayed on the operation unit illustrated in FIG. 1.

FIG. 5 illustrates an example of a UI displayed on the operation unit illustrated in FIG. 1.

FIG. 6 illustrates a flowchart illustrating an example of display processing performed by the image processing apparatus.

FIG. 7 illustrates an example of a UI displayed on the operation unit illustrated in FIG. 1.

FIG. 8 illustrates a flowchart of a display processing example of the image processing apparatus.

### DESCRIPTION OF THE EMBODIMENTS

Various exemplary embodiments, features, and aspects of the invention will be described in detail below with reference to the drawings.

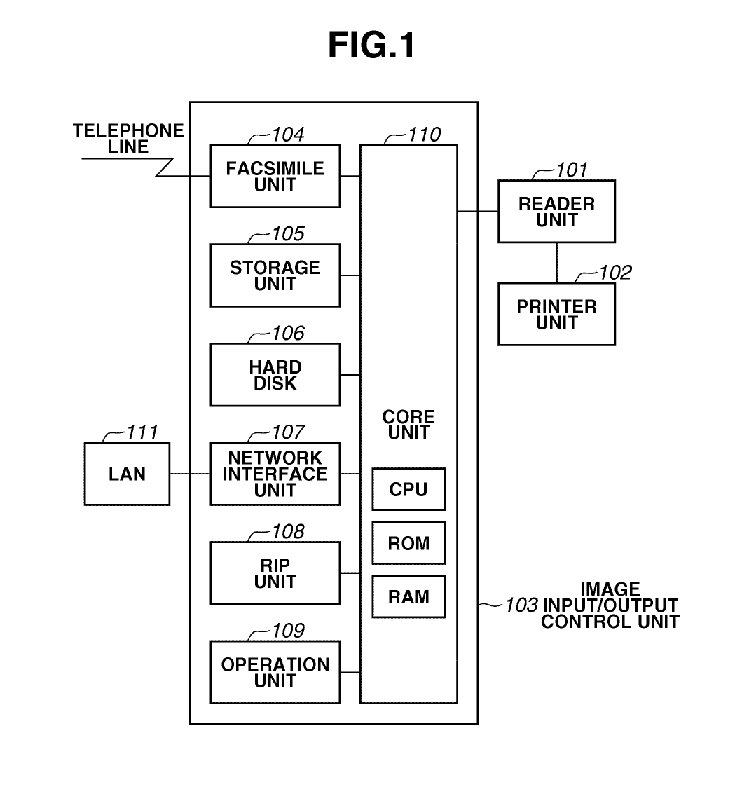

FIG. 1 is a block diagram illustrating the configuration of an image processing apparatus according to an exemplary embodiment of the present invention. The example illustrates an MFP or an image processing apparatus configured to enable execution of a plurality of functional processes as an example of an information processing apparatus. The information processing apparatus stores setting information set by a user based on each function in a memory, and when a user mode is set using a user interface, the information processing apparatus is configured to enable execution of functional processing reflecting the registered settings.

In FIG. 1, a reader unit 101 reads an image of a document and outputs image data according to the document image to an image input/output control unit 103. A printer unit 102 records an image according to the image data from the image input/output control unit 103 on recording paper. The image input/output control unit 103 is connected to the reader unit 101 and the printer unit 102 and includes a facsimile unit 104, a storage unit 105, a hard disk (HDD) 106, a network interface unit 107, a raster image processor (RIP) 108, an operation unit 109, and a core unit 110.

The facsimile unit 104 decompresses compressed image data received via a telephone line, transfers the decompressed image data to the core unit 110 or compresses image data transferred from the core unit 110, and sends the compressed image data via a telephone line. Received and sent image data can be temporarily saved in the HDD 106, which is connected to the storage unit 105. The storage unit 105 compresses the image data transferred from the core unit 110 and stores the image data together with an ID number used to enable searching for the image data in the HDD 106.

The storage unit 105 searches for compressed image data stored in the HDD 106 based on code data transferred via the core unit 110, reads and decompresses identified compression image data, and transfers the decompressed image data to the core unit 110. The network interface unit 107 is an interface between a network 111 and the core unit 110. The RIP unit 108 rasterizes code data (page description language (PDL)) transferred from the network 111 to image data that is usable for recording by the printer unit 102.

The operation unit 109 is provided with a touch panel display and hard key to enable operation commands and operation settings to the image processing apparatus via a user interface. The core unit 110 controls the flow of data among the reader unit 101, the printer unit 102, the facsimile unit 104, the storage unit 105, the network interface unit 107, the RIP unit 108, and the operation unit 109. The core unit 110 includes a central processing unit (CPU), a read only memory (ROM), and a random access memory (RAM). The CPU executes overall control of the apparatus by executing programs stored in the ROM on the RAM.

The image processing apparatus illustrated in FIG. 1 provides functional processing including copying, printing, data transmission, facsimile, box, and pull-printing in response to user settings. The copying function is configured to print documents read by the reader unit 101 using the printer unit 102. The printer function is configured to execute printing of print data received from an external apparatus via the network interface unit 107 using the printer unit 102. The data transmission function is configured to send image data stored in the HDD 106 or document image data read using the reader unit 101 via the network interface unit 107 to an external apparatus. The facsimile function is configured to send image data to an external apparatus via the facsimile unit 104 and a telephone line. The box function is configured to store document image data read by the reader unit 101 or image data received from an external apparatus via the network interface unit 108 in the HDD 106. The pull-printing function is configured to print image data received from an external apparatus via the network interface 107 using the printer unit 102 based on commands from the operation unit 109.

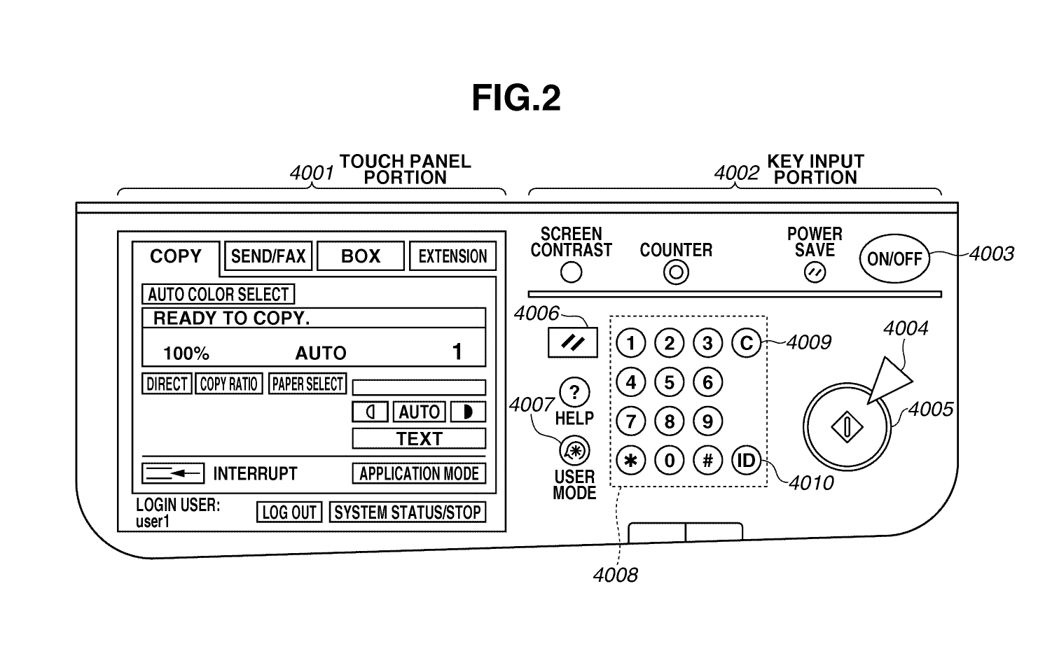

FIG. 2 is a plan view illustrating the configuration of the operation unit 109 illustrated in FIG. 1. In FIG. 2, the operation unit 109 includes a key input portion 4002, which is configured to receive user operations via a hard key, and a touch panel portion 4001, which enables display of display keys (soft keys) and receipt of user operations via the soft keys. Firstly the key input portion 4002 will be described.

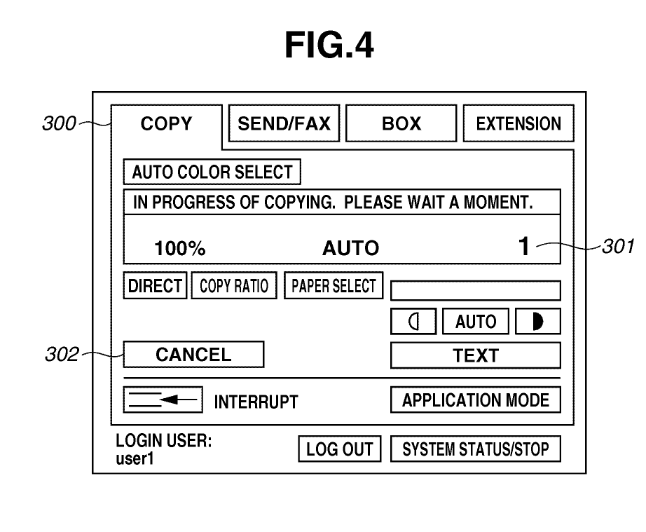

As illustrated in FIG. 4, the key input portion 4002 is provided with a power source switch 4003 for the operation unit 109. When the power switch 4003 is pressed by a user, the core unit 110 determines requests for each functional processing or an end status of each functional processing and selectively switches between a standby mode (normal operating status) and a sleep mode (power saving status). The core unit 110 receives user operations by the power switch 4003 when the main power switch (not illustrated), which executes overall system power supply, is in the ON position.

A start key 4005 is used to receive commands for commencing requests for respective functional processes from a user. The respective functional processes include copying operations by the reader unit 101 or processing for sending image data stored in the HDD 106 via the network interface unit 107 to an external apparatus. A stop key 4004 is used to receive processing suspension commands for received print jobs from a user. A numeric keypad 4008 enables a user to set a numeric value for each type of setting.

A clear key 4009 is used to delete input values such as a user ID, a password, or the like input by a user via the numeric keypad 4008. A reset key 4006 is used to receive a user command to invalidate various settings input by the user for a print job and to return set values to a default status. The user mode key 4007 is used to shift to a system setting screen for respective users.

An ID key 4010 is used for user authentication. When the ID key 4010 is pressed, the core unit 110 displays a login screen on the touch panel portion 4001. The core unit 110 executes user authentication using a user ID or password input via the login screen.

Next, the touch panel portion 4001 will be described. The touch panel portion 4001 has a touch panel display including an LCD with transparent electrodes adhered to the LCD. The touch panel portion 4001 includes the function of receiving various settings from an operator and the function of providing information to an operator. For example, when it is detected that a user has pressed a position corresponding to a display key displayed on the LCD, the core unit 110 executes the processing of the display key according to a display control program stored in the ROM. The details of the screen displayed on the touch panel portion 4001 will be described below.

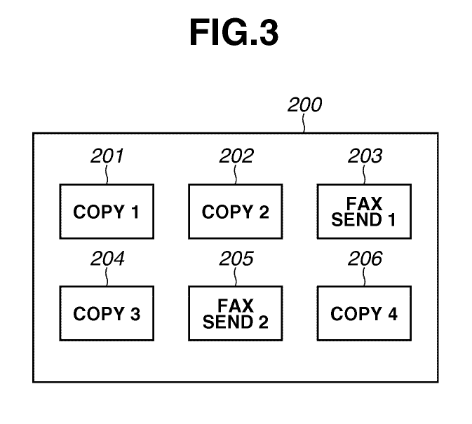

FIG. 3 illustrates an example of a user interface displayed on the operation unit 109 illustrated in FIG. 1. The example is displayed by pressing an extension button displayed on the touch panel portion 4001. In FIG. 3, the buttons 201-206 (buttons may also be termed “keys”) are disposed on a registered-button display screen 200. Functions provided by the image processing apparatus illustrated in FIG. 1, for example, settings for execution of functions including copying, data transmission or facsimile, or settings for executing process contents are registered in any one of the buttons 201-206 (button registration function). When a button is pressed, a function is provided in which processing is executed according to process contents registered in advance in association with the button (button execution function). Button selection may be executed using a method other than a method in which a user presses a button via the touch panel portion 4001. For example, selection may be performed by a hard key provided in the key input portion 4002. In that case, a user may move a cursor (not illustrated) on the touch panel portion 4001 using the keys provided on the key input portion 4002 (for example, the “4” key and the “6” key) and perform selection by pressing a determination key (for example “5” key).

Normally, execution of the data transmission function is executed by a user performing operations (1) to (4) below. (1) settings including the level of resolution, designating color or black and white, the copy ratio, the reading density, and the image quality. (Hereafter these settings will be termed “reading settings”). (2) Selection of the transmission method such as e-mail or file transfer protocol (FTP). (3) Setting a destination. (4) Placing a document on the document positioning plate. A user can execute a data transmission function by executing each of the operations (1) to (4) above.

However, the image processing apparatus, which includes the button registration function and the button execution function, may be operated as described below.

The setting contents which are set according to the operations (1) to (3) may be registered in any one of the buttons 201-206 on the registered-button display screen 200. When executing a data transmission function, a user calls up settings (1) to (3) with a single touch by pressing a registered button illustrated in FIG. 3.

Thereafter, the user may place a document on the document positioning plate and start data transmission using the same settings as a normal operation. In other words, when there is a high frequency of using the data transmission function with the same settings, once setting contents are registered in a button, user operations are extremely simple. When a user as in the operation (4) above places a document on the document positioning plate in advance and presses the button illustrated in FIG. 3, the document on the document positioning plate can be read according to the settings corresponding to the button and transmitted after image processing. In addition to data transmission functions, process contents may be registered in association with a button in relation to other functions. For example, with regard to the copying function, the number of copies or process contents for post-processing such as stapling processing may be registered in association with a button.

FIG. 4 illustrates an example of a UI displayed on the operation unit 109 illustrated in FIG. 1. The screen is an operation status screen displayed on the UI, which is configured to display a plurality of buttons illustrated in FIG. 3, when a screen transition is executed by pressing of the button 201 for copy 1. In the example, when the button which is configured to record the copying process contents is pressed, the screen switches to an application screen 300 for copying and a child screen 301 configured to display a message that copying is currently in progress is displayed.

A button 302 for canceling (suspending) currently executed processing is provided on the image processing apparatus to thereby enable interruption of processing. In the present embodiment, display control is executed by the core unit 110, which switches to an application screen configured to execute processing operations registered in a button illustrated in FIG. 3. In this manner, when the current processing status of functional processing is confirmed by a user, the status can be confirmed via the operation unit 109. Furthermore, after confirming a current processing status, the button 302 enables the current processing to be cancelled depending on the status. For example, when an error occurs during processing, since the application screen 300 illustrated in FIG. 4 switches to the screen that displays error contents, there is the advantage that an immediate error response is provided. The contents of the settings registered in the button that is pressed may be displayed on the application screen 300 illustrated in FIG. 4. For example, when a button associated with a process defined by “produce 10 copies, and staple the copied sheets” is pressed, the core unit 110 displays “10” in the field indicating the number of copies on the screen illustrated in FIG. 4. Furthermore, the core unit 110 displays “stapling required” in the field indicating the presence or absence of stapling.

When a setting not provided in a field in the screen illustrated in FIG. 4 is registered in association with a button, the process contents may be displayed in the message field. For example, it is assumed that registered contents are assigned to a button set to execute copying and a page number is applied to a sheet printed during copying. In the example of the screen illustrated in FIG. 4, the function that applies a page number is enabled by settings on the screen displayed by pressing an application mode button on the screen illustrated in FIG. 4 and direct settings cannot be executed using the screen illustrated in FIG. 4.

As a result, there is no dedicated field indicating a setting of applying a page number on the screen illustrated in FIG. 4. In this case, when a button with a setting that applies a page number is pressed, a message field is provided in the displayed screen illustrated in FIG. 4 and is used to provide a display to the effect that a page number has been applied. In this manner, a user can confirm a current processing status by simply comprehending the currently executed process contents from the screen illustrated in FIG. 4 without switching among a plurality of screens.

However, as illustrated in FIG. 4, when switching to an application screen 300 used to execute processing operations registered in a button, processes executed by the other button buttons 201-206 registered in the registered-button display screen 200 cannot be executed until ending of the current processing operation. Furthermore, when a single user wants to continuously execute the plurality of buttons 201-206 registered in the registered-button display screen 200, time and trouble are caused by the requirement to press the next button after waiting for each process to be completed. After execution of a process corresponding to one button, the core unit 110 can also execute display control by automatically returning to the registered-button display screen 200 from the copy execution screen.

However, since performance of 100 copies takes a considerable time, although it is possible to return to the registered-button display screen 200 during display of the copy execution screen corresponding to the application screen 300 illustrated in FIG. 4 if a button is provided which is used to return to the registered-button display screen 200 at an arbitrary timing, the number of unnecessary operations is further increased.

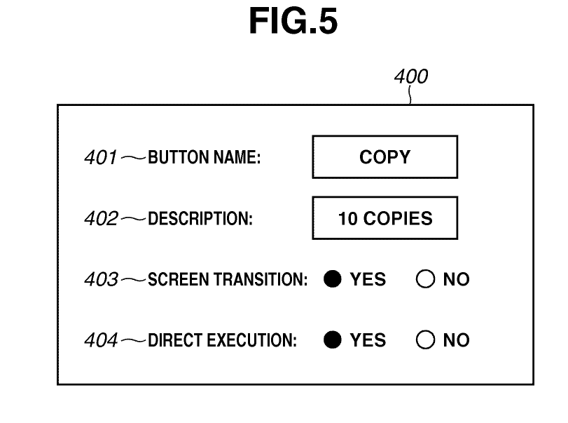

FIG. 5 illustrates an example of a UI displayed on the operation unit 109 illustrated in FIG. 1. This example shows an operation status screen according to button selection. The screen 400 corresponds to a screen used to register a plurality of buttons 201-206 displayed on the registered-button display screen 200 illustrated in FIG. 2. An example of registering these buttons will be described hereafter. For example, a user firstly displays the screen of an application used to execute the process to be registered (copy screen or data transmission screen) and sets process contents such as the number of copies or density settings. A setting registration button (not illustrated) provided on the screen is pressed. When the setting registration button is pressed, the core unit 110 generates button information showing information for the button used for display on the screen illustrated in FIG. 4 and registers the set process contents as button information in the HDD 106. In the present embodiment, the core unit 110 includes button information which can be registered in the button such as information related to button name, button description, and screen transition or information related to direct processing execution. The method of registering information is described below.

FIG. 5 illustrates a screen displayed on the operation unit 109 when a setting registration button is pressed. In FIG. 5, a user performs settings including, for example, button name 401 or button description 402. The button name 401 or the button description 402 is input using a software keyboard displayed when the respective items are selected. In addition, a YES/NO item 403 is provided to enable selection of “execute or not execute screen transition by pressing button”.

An item 404 is provided to enable selection of “execute directly or not execute directly processing corresponding to the button when the button is pressed”. The core unit 110 stores the set contents as button information for the button in the HDD 106 according to the contents selected by a user in response to pressing of an OK key (not illustrated). When the screen illustrated in FIG. 4 is displayed, the core unit 110 displays a button on the screen illustrated in FIG. 4 according to the button information registered in the HDD 106.

Settings for direct execution, for example, a button used for copying operations, may only be set to copy of 10 copies, or may be set to copy of 10 copies and execute processing until completion of 10 copies.

When a user selects not to perform screen transition in the item 403 and sets the item 404 so that execution will not be performed directly, the print processing of copies, for example, will only be performed with two-sided printing settings and screen transition will not be performed. Since these settings are not effective for a user, when no screen transition has been selected in the item 403, control may be performed to disable selection not to permit direct execution. For example, when no screen transition is selected in the item 403, the core unit 110 may be set to forcibly permit direct execution of items, which have been set to not be directly executed.

The core unit 110 displays the item 403 as a command used to determine whether to execute processing according to the button or whether to execute only settings according to the button without switching to a screen that displays the processing status according to the button. The user selects a radio button corresponding to “YES, NO” displayed in the item 403 on the UI, and the core unit 110 recognizes the selection status and stores the status in a memory such as a RAM.

Next it is assumed that the user has selected no screen transition in the item 403 on the UI and selected direct execution in the item 404. In this case, the core unit 110 executes control so that the UI screen recognizes selection using other buttons and the processing corresponding to the button is executed without display of the processing status corresponding to the previously selected button.

When no screen transition is selected in the item 403 and no direct execution is selected in the item 404, the core unit 110 receives the selection corresponding to another button on the UI screen and performs control so that only setting can be performed and the corresponding button processing is not executed. Furthermore, when screen transition is selected in the item 403 and direct execution is selected in the item 404, the core unit 110 executes processing corresponding to the button and displays the processing status corresponding to the button. The information received during this processing is registered in the HDD 106 as button information.

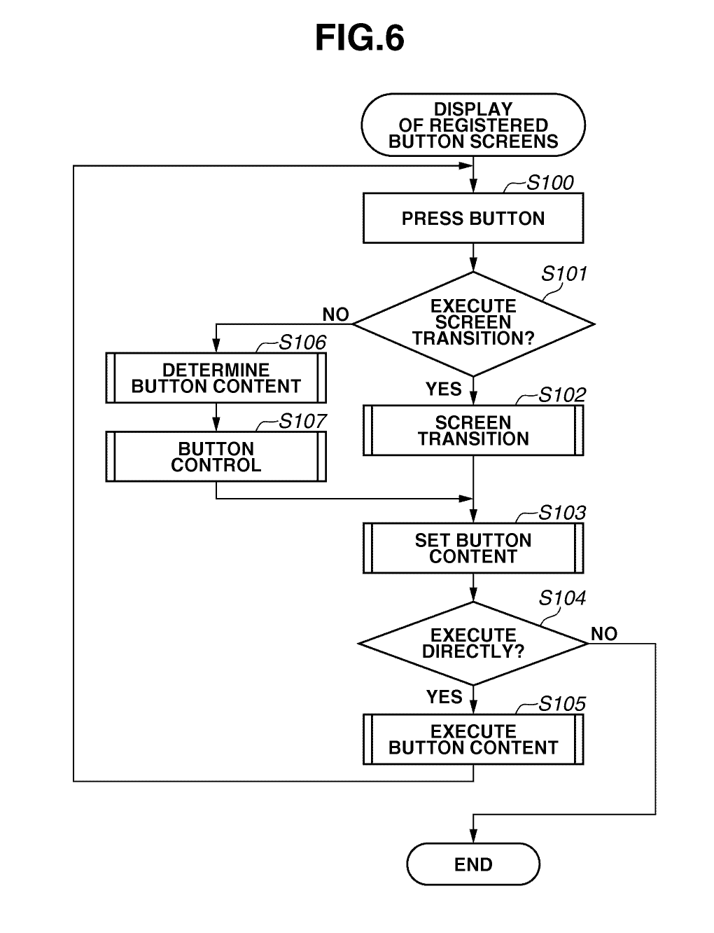

FIG. 6 illustrates a flowchart illustrating an example of display processing on the operation screen performed by the image processing apparatus according to the present exemplary embodiment. This example shows operation processing when any of the buttons 201-206 is pressed on the registered-button display screen 200. Each step is implemented by the core unit 110 executing control programs stored in the ROM by loading onto the RAM. Screen control when a registered button in the present embodiment is selected on the user interface will be described below.

Although the screen control is executed by the CPU of the core unit 110, when a UI is acquired via a browser from a server on a network, screen control also includes application screens used to execute display control according to user commands.

Firstly in step S100, buttons 201-206 registered on the registered-button display screen 200 are confirmed, and the user presses a button to be executed. Then in step S101, after the user has pressed the button, the core unit 110 determines whether screen transition has been registered in the item 403 “screen transition “YES NO”” on the screen 400. When the core unit 110 determines that screen transition has been registered, the process proceeds to step S102, in which screen transition is executed to an application used to execute processing registered in the button. Then, the process proceeds to step S103.

On the other hand, in step S101, when the core unit 110 determines that screen transition is not executed, the process proceeds to step S106. In step S106, the core unit 110 determines the contents of the button registered. After determining the contents of the button, for example, that the button is used to execute copying, the process proceeds to step S107. In step S107, the display of the registered-button display screen 200 on the touch panel 4001 is maintained and any button configured to execute the same copying process from the other buttons 201-206 displayed on the registered-button display screen 200 is invalidated. In other words, control is executed so that a user cannot press a button for executing the same copying process.

However, even when the button contents are determined in step S106, a buttons registered for execution of facsimile transmission remains valid to enable executing processing. After the button control in step S107, the process proceeds to step S103. In this manner, the core unit 110 executes display control to disable selecting a button used to execute the same type of processing as the processing executed by the button that has been pressed. On the other hand, the core unit 110 executes display control to enable selecting a button used to execute a different type of processing from the processing of the button that has been pressed. Consequently, pressing buttons for executing the same type of processing in succession can be avoided. More specifically, when using an MFP that does not execute the same type of processing in parallel, it is possible to avoid processing delay in relation to a subsequently pressed button.

In step S103, the process contents registered in association with the buttons 201-206 are set. For example, when a button used to execute copying is pressed, contents such as two-sided copy, the number of 20 copies and the like are set. In step S103, when the contents of the buttons 201-206 are set, the process proceeds to step S104. In step S104, the core unit 110 determines whether direct execution is performed. When it is determined that direct execution is not performed, the series of processes ends at that point.

On the other hand, in step S104, when the core unit 110 determines from the determination of “direct execution YES NO” in the item 404 in FIG. 5 that direct execution is not performed, the process proceeds to step S105. In step S105, the core unit 110 executes the process contents set in step S103. After completion of processing in step S105, the series of processes ends at that point.

When the core unit 110 has determined that screen transition is not executed in the determination of “screen transition YES NO” in step S101, screen transition is not executed even when the processing in step S105 is executed. Consequently, the process returns to the initial flow in FIG. 6 and proceeds to step S100 to thereby enable selection by pressing valid buttons of the buttons 201-206.

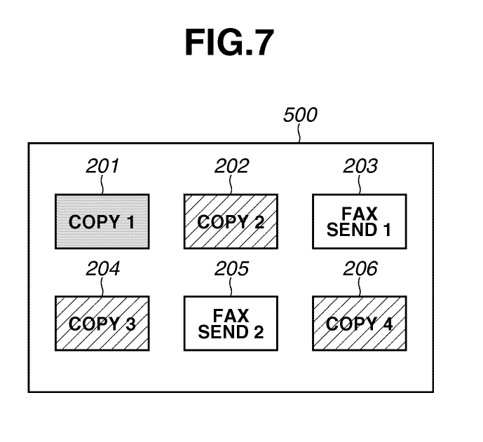

FIG. 7 illustrates an example of a UI displayed on the operation unit 109 illustrated in FIG. 1. The screen is displayed for example, after executing copy 1 using the button 201 in step S100 described with reference to FIG. 5. In FIG. 7, the buttons 202, 204, and 206 with cross hatching indicate a state in which selection is not possible due to selection of the button 201.

Herein, it is assumed that information, such as direct execution in the item 404 and no screen transition in step S403, has been registered in the button 201 on the screen 400. In this case, in step S107, a status in enabled in which the button 201 which has been pressed and the buttons for executing another copy are invalid. Although at this time, all of the buttons used to execute copying are invalidated, the buttons 203 and 205 for facsimile transmission have a valid status and thereby enable execution of parallel processing even when copying processes are executed. When another button is operated, the core unit 110 controls the display so that buttons which cannot execute processing at the same time as the previously operated button cannot be selected and thereby prevents a user from selecting an erroneous button.

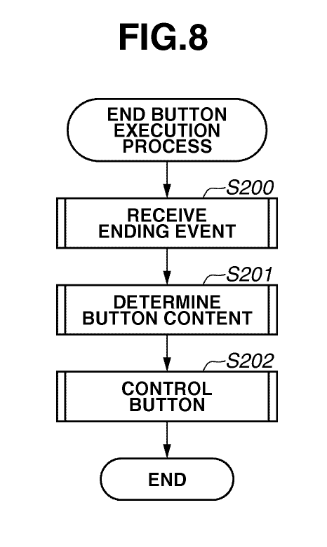

FIG. 8 illustrates a flowchart illustrating an example of display processing on the operation screen performed by the image processing apparatus according to the present exemplary embodiment. The present example illustrates operation processing in which a button which has been invalid is returned to a valid status when an operation process executed in step S100 illustrated in FIG. 6 is completed.

A process of returning a previously invalid button to a valid status will be described below after execution of copy 1 on the button 201, for example, in step S100 in FIG. 6 on the screen 500 having a status in which the button 201 and other buttons used to execute copying are invalid. Each step is implemented by the core unit 110 executing a control program stored in the ROM by loading onto the RAM.

Firstly in step S200, the core unit 110 receives an ending notification upon completion of processing executed as a result of pressing the button 201, for example, on the registered-button display screen 200. Then in step S201, the core unit 110 determines the button contents, such as the application which has been used in execution of the processing. After determination of the button contents in step S201, the process proceeds to step S202. In step S202, the core unit 110 returns the button 201 and the buttons for executing other copying, which have been invalidated, to a valid status and then end the process. The invalid status is a state in which selection via the operation unit 109 is not possible and the valid status is a status in which selection via the operation unit 109 is possible.

According to the above control process, in response to selection of a button (key) included in an operation screen, information as to whether to display a processing status corresponding to the button or whether to maintain display on the operation screen can be set in association with the button. The display can be switched according to the setting. For example, a setting may enable a screen to be switched to a screen of an application for executing a process corresponding to the button while the process corresponding to the button is executed to thereby enable confirmation by a user of a processing status. Furthermore, if the button is a button associated with a simple process that does not require processing status confirmation, after pressing the button, the process may be executed without screen transition to thereby enable pressing other buttons in sequence. Therefore, after pressing the registered button, a user can issue commands for a plurality of processes in sequence without performing an operation to return the screen to an original screen.

Furthermore, when a process corresponding to the pressed button is executed, a user can be prevented from successively issuing commands for the same processing, since processes that are similar to the executed process are displayed in a non-selectable manner. In this manner, it is possible to prevent successive commanding of the same processing using the same printer unit 102, for example, and thereby processing delay of a subsequently commanded process can be prevented.

Although the present embodiment is directed to an example of an operation screen based on functional processing by an image processing apparatus, the present invention can also be applied to a data processing apparatus other than the image processing apparatus as long as the data processing apparatus is capable of registering functional settings.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-113302 filed May 8, 2009, which is hereby incorporated by reference herein in its entirety.

What is claimed is:

1. An information processing apparatus configured to display an operation screen including a plurality of keys on a display unit, and when any one of the plurality of keys is selected, to execute a process according to a process content registered in association with the selected key, the information processing apparatus comprising:
a setting unit configured to set, for each key of the plurality of keys, whether to cause the display unit to display a status of a process executed in response to selection of the selected key included in the operation screen; and
a display control unit configured to control the display unit to display the status of the process corresponding to the selected key if it is set by the setting unit to cause the display unit to display the status of the process executed in response to selection of the selected key when the key is selected, and to maintain display of the operation screen including the plurality of keys if it is not set by the setting unit to cause the display unit to display the status of the process executed in response to selection of the selected key when the key is selected.

2. The information processing apparatus according to claim 1, wherein the display control unit is configured to control the display unit, in response to selection of the selected key, to disable selection of a key registered for a process that cannot be executed in parallel with the process registered in association with the selected key among the plurality of keys included in the operation screen.

3. The information processing apparatus according to claim 1, wherein the setting unit is configured to set, in response to selection of the selected key, whether to execute a process registered in association with the selected key or whether to perform, without executing the process registered in association with the selected key, setting for executing the registered process.

4. The information processing apparatus according to claim 1, wherein the display control unit is configured to control the display unit to maintain display of the operation screen including the plurality of keys if it is not set by the setting unit to cause the display unit to display the status of the process executed in response to selection of the key when the key is selected.

5. The information processing apparatus according to claim 1, wherein the process according to the process content is a process for copying, data transmission, or storing data in a storage unit.

6. A control method for controlling an information processing apparatus configured to display an operation screen including a plurality of keys on a display unit, and when any one of the plurality of keys is selected, to execute a process according to a process content registered in association with the selected key, the control method comprising:
setting, for each key of the plurality of keys, whether to cause the display unit to display a status of a process executed in response to selection of the selected key included in the operation screen; and
controlling the display unit to display the status of the process corresponding to the selected key if it is set to cause the display unit to display the status of the process executed in response to selection of the selected key when the key is selected, and to maintain display of the operation screen including the plurality of keys if it is not set to cause the display unit to display the status of the process executed in response to selection of the selected key when the key is selected.

7. A computer-readable storage medium storing computer-executable instructions for controlling an information processing apparatus configured to display an operation screen including a plurality of keys on a display unit, and when anyone of the plurality of keys is selected, to execute a process according to a process content registered in association with the selected key, the computer-executable instructions comprising:
instructions for setting, for each key of the plurality of keys, whether to cause the display unit to display a status of a process executed in response to selection of the selected key included in the operation screen; and
a code to control the display unit to display the status of the process corresponding to the selected key if it is set to cause the display unit to display the status of the process executed in response to selection of the selected key when the key is selected, and to maintain display of the operation screen including the plurality of keys if it is not set to cause the display unit to display the status of the process executed in response to selection of the selected key when the key is selected.
